(19) United States
(12) Patent Application Publication
(10) Pub. No.: US 2015/0084439 A1
(43) Pub. Date: Mar. 26, 2015

(54) SHORTING ASSEMBLY AND METHOD FOR WIND TURBINE POWER SUPPLY

(71) Applicant: General Electric Company, Schenectady, NY (US)

(72) Inventors: Joseph Andrew Trzemzalski, Mauldin, SC (US); John Noel Cunningham, Smyrna, GA (US); David McNeill Reese, Greer, SC (US)

(73) Assignee: General Electric Company, Schenectady, NY (US)

(21) Appl. No.: 14/033,729

(22) Filed: Sep. 23, 2013

(51) Int. Cl. H02H 11/00

(52) U.S. Cl. CPC H02H 11/00
USPC 307/326

(57) ABSTRACT

Shorting assemblies, shorting devices, and methods for shorting wind turbine power supplies are provided. A shorting device may include a plurality of cables, each of the plurality of cables including a first end and a second end. The shorting device may further include a plurality of bus bar connectors, each of the plurality of bus bar connectors attached to the first end of one of the plurality of cables and removably connectable to one of the plurality of bus bars. The shorting device may further include a common cable connector, the second end of each of the plurality of cable attached to the common cable connector.

### FIELD OF THE INVENTION

The present disclosure is directed to wind turbine power supplies, and more particularly to shorting devices, shorting assemblies and methods for shorting wind turbine power supplies.

### BACKGROUND OF THE INVENTION

Wind power is considered one of the cleanest, most environmentally friendly energy sources presently available, and wind turbines have gained increased attention in this regard. A modern wind turbine typically includes a tower, generator, gearbox, nacelle, and one or more rotor blades. The rotor blades capture kinetic energy of wind using known airfoil principles. The rotor blades transmit the kinetic energy in the form of rotational energy so as to turn a shaft coupling the rotor blades to a gearbox, or if a gearbox is not used, directly to the generator. The generator then converts the mechanical energy to electrical energy that may be deployed to a utility grid.

In many instances, it may be desirable to stop the generator from operating or being capable of operating. For example, during routine maintenance or repairs, it is desirable to “lock out” the generator using a “lock out tag out” procedure to ensure that the generator does not injure a worker. Presently known procedures for locking out a generator, however, are cumbersome and time consuming. For example, workers are currently required to climb the wind turbine tower to access the generator in the nacelle directly. After climbing the wind tower, the workers can apply a rotor lock pin into the generator's shaft, to physically prevent spinning, or can apply locks to a generator in-line circuit breaker after visually verifying that the breaker contacts are open. Because they require workers to climb the wind turbine tower and directly access the generator, however, such procedures increase labor costs and wind turbine downtime, and can increase safety risks to the workers.

Accordingly, improved methods and apparatus for locking out wind turbine generators are desired in the art. In particular, methods and apparatus that increase worker safety while reducing labor costs and wind turbine downtime are desired.

### BRIEF DESCRIPTION OF THE INVENTION

Aspects and advantages of the invention will be set forth in part in the following description, or may be obvious from the description, or may be learned through practice of the invention.

In one embodiment, a shorting assembly for a wind turbine power supply is disclosed. The shorting assembly includes a generator, and a plurality of bus bars in electrical communication with and disposed downstream of the generator. The shorting assembly further includes a shorting device removably connectable to the plurality of bus bars. The shorting device includes a plurality of cables, each of the plurality of cables including a first end and a second end. The shorting device further includes a plurality of bus bar connectors, each of the plurality of bus bar connectors attached to the first end of one of the plurality of cables and removably connectable to one of the plurality of bus bars. The shorting device further includes a common cable connector, the second end of each of the plurality of cable attached to the common cable connector.

In another embodiment, a shorting device for shorting a power supply, the power supply including a generator and a plurality of bus bars downstream of the generator, is disclosed. The shorting device includes a plurality of cables, each of the plurality of cables including a first end and a second end. The shorting device further includes a plurality of bus bar connectors, each of the plurality of bus bar connectors attached to the first end of one of the plurality of cables and removably connectable to one of the plurality of bus bars. The shorting device further includes a common cable connector, the second end of each of the plurality of cable attached to the common cable connector.

In another embodiment, a method for shorting a wind turbine power supply is disclosed. The method includes locating a plurality of bus bars, the plurality of bus bars in electrical communication with a generator of the wind turbine power supply and disposed in a downtower location. The method further includes connecting the plurality of bus bars to a common shorting component.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a side view of a wind turbine in accordance with one embodiment of the present disclosure;

FIG. 2 is a schematic view of a wind turbine power supply in accordance with one embodiment of the present disclosure;

FIG. 3 is a front view of a shorting device in accordance with one embodiment of the present disclosure;

FIG. 4 is a cross-sectional view of a portion of a shorting device removably connected to a wind turbine power supply in accordance with one embodiment of the present disclosure; and

FIG. 5 is a perspective view of a shorting device removably connected to a wind turbine power supply in accordance with one embodiment of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

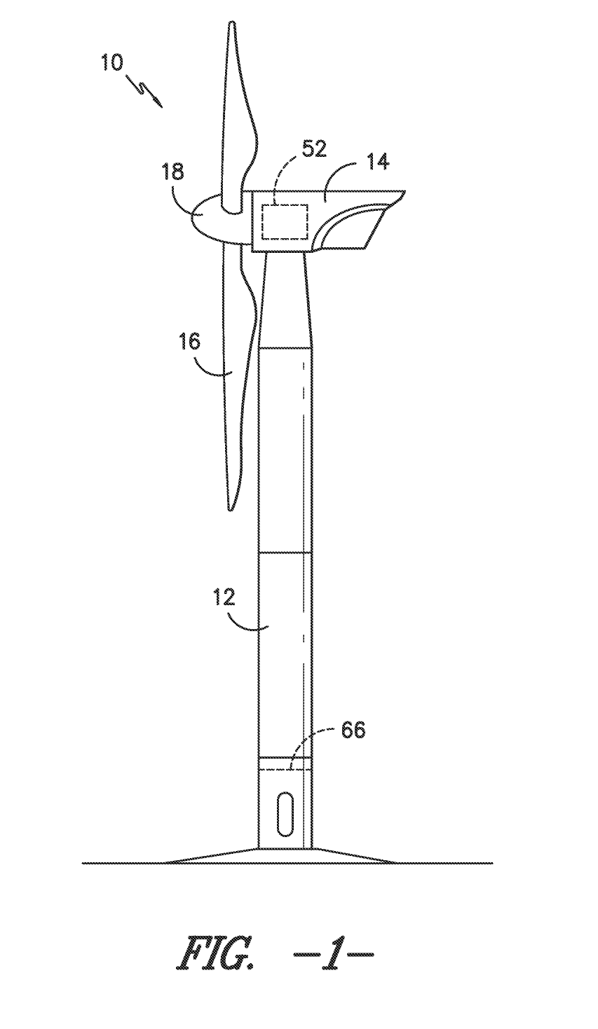

FIG. 1 illustrates a wind turbine 10 of conventional construction. The wind turbine 10 includes a tower 12 with a nacelle 14 mounted thereon. A plurality of rotor blades 16 are mounted to a rotor hub 18, which is in turn connected to a main flange that turns a main rotor shaft. The wind turbine power generation and control components are housed within the nacelle 14. The view of FIG. 1 is provided for illustrative purposes only to place the present invention in an exemplary field of use. It should be appreciated that the invention is not limited to any particular type of wind turbine configuration.

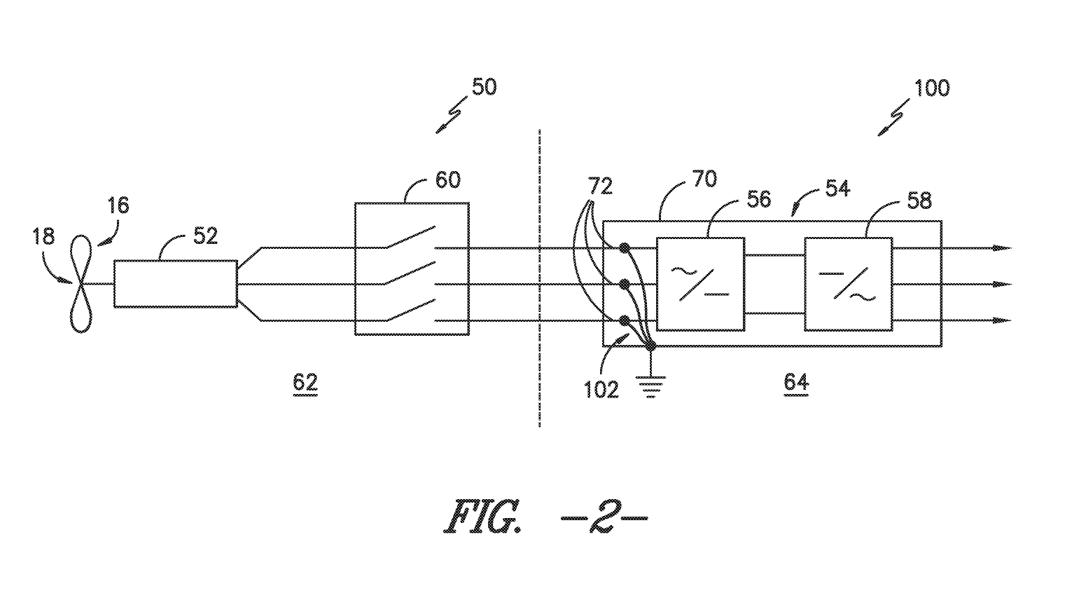

Referring now to FIG. 2, a power supply 50 for a wind turbine is illustrated. As shown, a generator 52 may be housed in the nacelle 14 (see FIG. 1). The hub 18 may be rotatably coupled to the generator 52 via, for example, a shaft and optional gearbox to permit electrical energy to be produced. Rotation of the rotor blades 16 may cause rotation of the hub 18 and thus rotation of a rotor of the generator 52, which may enable kinetic energy to be transferred from the wind into usable mechanical energy and subsequently electrical energy.

Generator 52 may be coupled to a power converter 54. The power converter 54 may be in electrical communication with and disposed downstream (relative to the flow of electrical power) of the generator 52. Output multiphase power, such as for example three-phase power, may be supplied from the generator 52, such as from the rotor of the generator 52, to the power converter 54. Specifically, generator 52 may be coupled to a rotor side converter 56 of the power converter 54. The rotor side converter 56 may in turn be coupled to a line side converter 58 of the converter 54. After being supplied to the converter 54 from the generator 52, power may flow to the grid. Additionally, in some embodiments, a main generator circuit breaker 60 may be provided between the generator 52 and the power converter 54, as shown.

Referring still to FIG. 2 as well as FIG. 1, various of the power supply 50 components may be disposed in uptower locations 62, while others of the power supply components may be disposed in downtower locations 64. An uptower location 62 is a location in a wind turbine 10 that is accessible generally by climbing up a majority of the tower 12. Thus, the nacelle 14 and upper platforms in the tower are considered uptower locations 62. A downtower location 64 is a location in a wind turbine 10 that is accessible generally without requiring climbing up a majority of the tower 12. Thus, lower platforms in the tower, as well as base platforms and locations at the base of the tower both inside and outside of the tower, are considered downtower locations 64. As shown, generator 52 may be disposed in an uptower location 62, such as in nacelle 14, while power converter 54 may be disposed in a downtower location 64, such as on a base platform 66 of the tower 12. Main circuit breaker 60 may in some embodiments additionally be disposed in an uptower location 62.

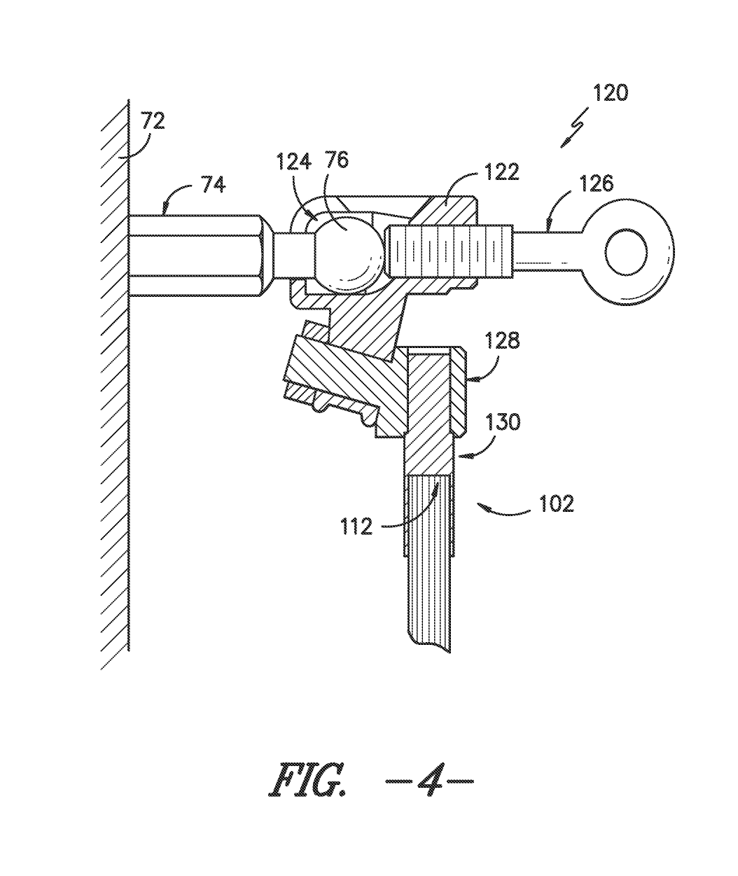

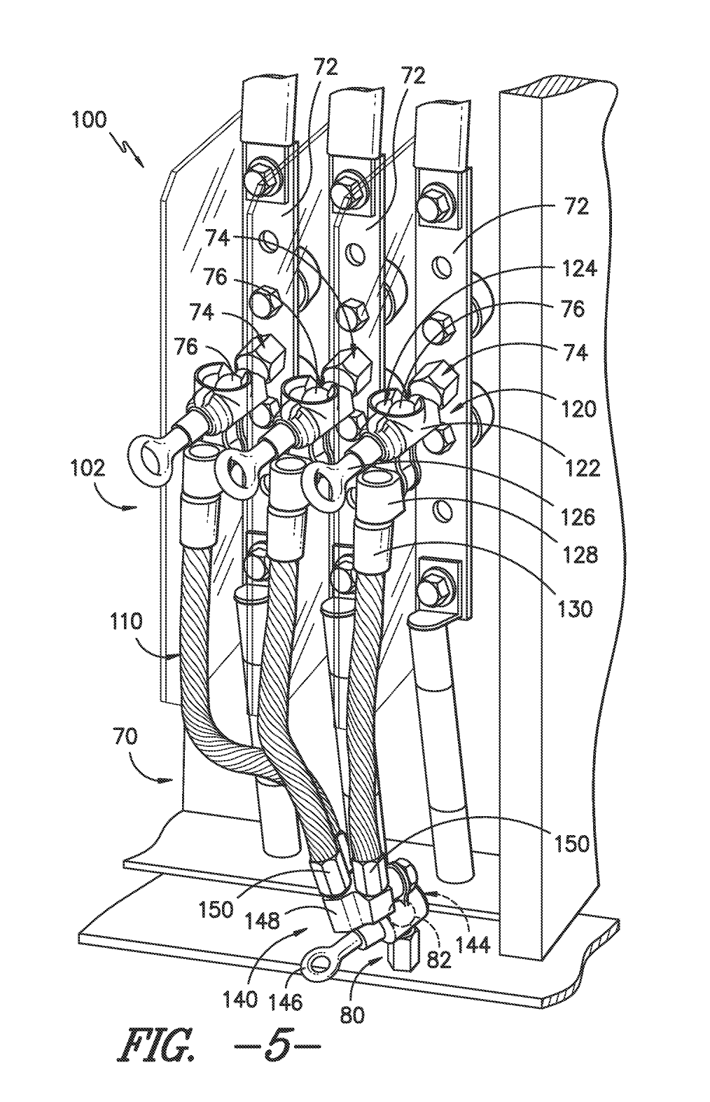

Referring still to FIG. 2 as well as to FIGS. 4 and 5, the power converter 54 may be disposed in a cabinet 70. A plurality of bus bars 72, which may also be disposed in the cabinet 70, may be in electrical communication with and disposed downstream of the generator 52. The bus bars 72 may further be in electrical communication with and disposed upstream of the power converter 54, such as upstream of the rotor side converter 56. In exemplary embodiments, three bus bars 72 are provided. Further, in some embodiments, ball stud 74 may extend from each bus bar 72. As shown, a ball stud 74 may include a ball end 76 distal from the bus bar 72. The bus bars 72 and ball studs 74 are in exemplary embodiments formed from a suitable metal or other suitable conductive material.

In some embodiments, a ground ball stud 80 may additionally be provided. The ground ball stud 80 may be similar to a ball stud 74, and may include a ball end 82, but may not be connected to and extending from a bus bar 72. Rather, a ground ball stud 80 may be connected to the cabinet 70 or another suitable location for establishing a voltage reference to ground potential.

As discussed above, improved apparatus for locking out the generator 52 are desired in the art. Accordingly, and referring now to FIGS. 2 through 5, the present disclosure is further directed to shorting assemblies 100 and shorting devices 102. A shorting assembly 100 according to the present disclosure may include, for example, a generator 52 and a plurality of bus bars 72. A shorting assembly 100 may further include a converter 54. In exemplary embodiments, the generator 52 may be disposed in an uptower location 62, while the bus bars 72, including the ball studs 74 thereon, as well as the converter 54 may be disposed in downtower locations 64.

A shorting assembly 100 may further include a shorting device 102. The shorting device 102 may be utilized to short the wind turbine 10 power supply 50. Advantageously, use of shorting devices 102 according to the present disclosure may increase worker safety while reducing labor costs and wind turbine downtime, by allowing worker to short the power supply 50 at downtower locations 64.

As shown, a shorting device 102 may include a plurality of cables 110. In exemplary embodiments, three cables 110 may be provided. Generally, the number of cables 110 may for example match the number of bus bars 72. Each cable 110 may include a first end 112 and a second end 114. A cable 110 may be formed from any suitable conductive material, such as for example copper or another suitable metal. In exemplary embodiments, a cable is formed from a braided copper.

A shorting device 102 may further include a plurality of bus bar connectors 120. Each bus bar connector 120 may be attached to the first end 112 of a cable 110, and may be removably connectable to one of the plurality of bus bars 72. Referring to FIG. 4, for example, one embodiment of a bus bar connector 120 is illustrated. The bus bar connector 120 may include a ball clamp 122. The ball clamp 122 may include a socket 124 defined therein. The connector 120 may further include an adjustable bolt 126. The bolt 126 may be threadably engaged with the ball clamp 122, such that adjustment of the bolt 126 increases or decreases the usable size of the socket 124. In these embodiments, the bus bar connector 120 may be removably connectable to the ball stud 74 of a bus bar 72. For example, to connect the device 102 to a bus bar 72, the ball end 76 may be placed into the socket 124. The bolt 126 may then be adjusted to contact the ball end 76, thus connecting the device 102 and bus bar 72. It should be understood, however, that the present disclosure is not limited to the above-disclosed apparatus for removable connection to a ball stud 74. Rather, any suitable connecting means for connecting a shorting device 102 to a bus bar 72 are within the scope and spirit of the present disclosure.

As mentioned, a bus bar connector 120 may be attached to a first end 112 of a cable 110. For example, referring still to FIG. 4, a bus bar connector 120 may include a single-cable fitting 128, to which the first end 112 of a cable 110 may be attached. The fitting 128 may further be attached to a ball clamp 122 as shown or other suitable component, such as through a threadable connection. Further, a bus bar connector 120 may include a compression lug 130, which may attach the first end 112 of a cable 110 to the fitting 128. For example, the first end 112 may be compression fit into the compression lug 130, and the compression lug 130 may be attached to the fitting 128, such as through a threadable connection as shown. Alternatively, however, any suitable attachment between the cable 110 and bus bar connector 120 is within the scope and spirit of the present disclosure.

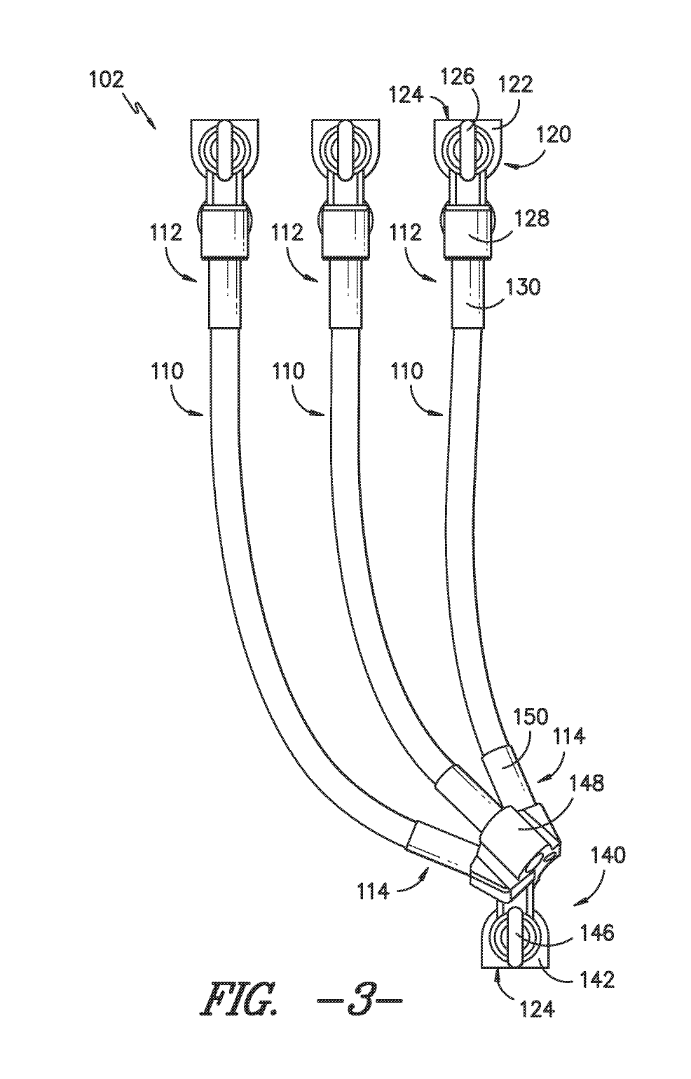

A shorting device 102 according to the present disclosure may further include a common cable connector 140. The common cable connector 140 may be attached to the second ends 114 of each cable 110 of the shorting device 102. Further, in some embodiments, the common cable connector 140 may be removably connectable to a point of zero electrical potential, such as the cabinet 70 or ground ball stud 80. However, it should be understood that the shorting device 102 need not necessarily be connected to a point of zero electrical potential in order to achieve a shorting effect on the generator. Referring to FIGS. 3 and 5, for example, one embodiment of a common cable connector 140 is illustrated. The common cable connector 140 may include a ball clamp 142, similar to the ball clamp of a bus bar connector 120. The ball clamp 142 may include a socket 144 defined therein. The connector 140 may further include an adjustable bolt 146. The bolt 146 may be threadably engaged with the ball clamp 142, such that adjustment of the bolt 146 increases or decreases the usable size of the socket 144. In these embodiments, the common cable connector 140 may be removably connectable to the ground ball stud 80. For example, to connect the device 102 to the ground ball stud 80, the ball end 82 may be placed into the socket 144. The bolt 146 may then be adjusted to contact the ball end 82, thus connecting the device 102 and ground ball stud 80. It should be understood, however, that the present disclosure is not limited to the above-disclosed apparatus for removable connection to a ground ball stud 80. Rather, any suitable connecting means for connecting a shorting device 102 to a point of zero electrical potential are within the scope and spirit of the present disclosure. Further, it should be understood that shorting device 102 need not be connected to a point of zero electrical potential, and rather that shorting device 102 operates to achieve a shorting effect on the generator merely by connecting cables 110 to the common cable connector 140.

As mentioned, the common cable connector 140 may be attached to a second end 114 of each cable 110. For example, referring still to FIGS. 3 and 5, a common cable connector 140 may include a multiple-cable fitting 148, such as a tri-cable fitting in exemplary embodiments, to which the second end 114 of each cable 110 may be attached. The fitting 148 may further be attached to the ball clamp 142 as shown or other suitable component, such as through a threadable connection. Further, a common cable connector 140 may include a plurality of compression lugs 150, which may attach the second end 114 of each cable 110 to the fitting 148. For example, the second end 114 of each cable 110 may be compression fit into the compression lug 150, and each compression lug 150 may be attached to the fitting 148, such as through a threadable connection as shown. Alternatively, however, any suitable attachment between the cables 110 and common cable connector 140 is within the scope and spirit of the present disclosure.

As mentioned, in some embodiments, the common cable connector 140 need not be connected to a point of zero electrical potential. In these embodiments, the common cable connector 140 still acts as the point of commonality for the shorting device 102 and shorting assembly 100. In other embodiments, the common cable connector 140 may be connected to a ground source, such as discussed above.

Connection of the shorting device 102 to the bus bars 72 may advantageously short the power supply 50, generally preventing the generator 52 from spinning fast enough to create a dangerous voltage level. Such shorting is caused because the various phases of power being generated by the generator 52 are shorted together by the shorting device 102 when the shorting device 102 is connected to each phase through connection to the bus bars 72. When shorted, the generator 52 is prevented from spinning at a relatively high rotational speed, because the shorting device 102 introduces a resistive rotational torque in a direction opposite to the direction in which the generator 102 is spinning.

Further, advantageously, use of a shorting device 102 and shorting assembly 100 according to the present disclosure may increase worker safety while reducing labor costs and wind turbine downtime, because the shorting device 102 can be utilized to short the power supply 50 from a downtower location 64, as discussed herein.

It should be understood that shorting devices 102 according to the present disclosure are not limited to use in wind turbines 10 with wind turbine power supplies 50, but rather that use with any suitable power supply 50 is within the scope and spirit of the present disclosure.

The present disclosure is further directed to methods for shorting a wind turbine power supply 50. A method may include, for example, the step of locating a plurality of bus bars 72. The plurality of bus bars 72 may be in electrical communication with a generator 52 of the wind turbine power supply 50 and disposed in a downtower location 64. A method may further include, for example, connecting the plurality of bus bars 72 to a common shorting component. In exemplary embodiments, for example, such connection may include removably connecting a shorting device 102 to each of the plurality of bus bars 72.

In some embodiments, the generator 52 is disposed in an uptower location 62. Further, in some embodiments, the wind turbine power supply 50 further comprises a converter 54, the converter comprising the plurality of bus bars 72.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A shorting assembly for a wind turbine power supply, the shorting assembly comprising:
a generator;
a plurality of bus bars in electrical communication with and disposed downstream of the generator; and
a shorting device removably connectable to the plurality of bus bars, the shorting device comprising:
a plurality of cables, each of the plurality of cables comprising a first end and a second end;
a plurality of bus bar connectors, each of the plurality of bus bar connectors attached to the first end of one of the plurality of cables and removably connectable to one of the plurality of bus bars; and
a common cable connector, the second end of each of the plurality of cable attached to the common cable connector.

2. The shorting assembly of claim 1, wherein each of the plurality of bus bar connectors comprises a ball clamp, the ball clamp comprising a socket, and an adjustable bolt.

3. The shorting assembly of claim 1, wherein each of the plurality of bus bar connectors comprises a single-cable fitting, the first end of each of the plurality of cables attached to one of the plurality of single-cable fittings.

4. The shorting assembly of claim 3, wherein each of the plurality of bus bar connectors further comprises a compression lug, the compression lug attaching the first end of each of the plurality of cables to one of the plurality of single-cable fittings.

5. The shorting assembly of claim 1, further comprising a plurality of ball studs, each of the plurality of ball studs extending from one of the plurality of bus bars, each of the plurality of bus bar connectors removably connectable to one of the plurality of ball studs.

6. The shorting assembly of claim 1, further comprising a ground ball stud, and wherein the common cable connector is removably connectable to the ground ball stud.

7. The shorting assembly of claim 6, wherein the common cable connector comprises a ball clamp, the ball clamp comprising a socket for housing the ground ball stud, and an adjustable bolt.

8. The shorting assembly of claim 1, wherein the common cable connector comprises a multiple-cable fitting, the second end of each of the plurality of cables attached to the multiple-cable fitting.

9. The shorting assembly of claim 1, wherein the generator is disposed in an uptower location and the plurality of bus bars, the plurality of ball studs, and the shorting device are disposed in a downtower location.

10. The shorting assembly of claim 1, further comprising a converter in electrical communication with and disposed downstream of the generator, the converter comprising the plurality of bus bars.

11. A shorting device for shorting a power supply, the power supply comprising a generator and a plurality of bus bars downstream of the generator, the shorting device comprising:
a plurality of cables, each of the plurality of cables comprising a first end and a second end;
a plurality of bus bar connectors, each of the plurality of bus bar connectors attached to the first end of one of the plurality of cables and removably connectable to one of the plurality of bus bars;
a common cable connector, the second end of each of the plurality of cable attached to the common cable connector.

12. The shorting device of claim 11, wherein each of the plurality of bus bar connectors comprises a ball clamp, the ball clamp comprising a socket, and an adjustable bolt.

13. The shorting device of claim 11, wherein each of the plurality of bus bar connectors comprises a single-cable fitting, the first end of each of the plurality of cables attached to one of the plurality of single-cable fittings.

14. The shorting device of claim 13, wherein each of the plurality of bus bar connectors further comprises a compression lug, the compression lug attaching the first end of each of the plurality of cables to one of the plurality of single-cable fittings.

15. The shorting device of claim 11, wherein the common cable connector comprises a ball clamp, the ball clamp comprising a socket, and an adjustable bolt.

16. The shorting device of claim 11, wherein the common cable connector comprises a multiple-cable fitting, the second end of each of the plurality of cables attached to the multiple-cable fitting.

17. A method for shorting a wind turbine power supply, the method comprising:
locating a plurality of bus bars, the plurality of bus bars in electrical communication with a generator of the wind turbine power supply and disposed in a downtower location; and
connecting the plurality of bus bars to a common shorting component.

18. The method of claim 17, wherein the wind turbine power supply further comprises a converter, the converter comprising the plurality of bus bars.

19. The method of claim 17, wherein the generator is disposed in an uptower location.

20. The method of claim 17, wherein the connecting step comprises removably connecting a shorting device to each of the plurality of bus bars.
